(19) United States
(12) Patent Application Publication
(10) Pub. No.: US 2004/0223828 A1
(43) Pub. Date: Nov. 11, 2004

(54) Fastening device

(75) Inventors: James Arthur Lazaruk, Calgary (CA); Michael Joseph Hammerschmidt, Calgary (CA)

Correspondence Address: BENNETT JONES, 4500 Bankers Hall East, 855 - 2nd Street SW, Calgary, AB, T2P 4K7, CA

(73) Assignee: SWAMP MATS INC.

(21) Appl. No.: 10/429,255

(22) Filed: May 5, 2003

(51) Int. Cl. F16B 21/00

(52) U.S. Cl. 411/349

(57) ABSTRACT

The present invention comprises a fastener including a rigid fastener body formed of two sections attached together and shaped so as to be insertable into a hole in a mat. The body being formed so that the fastener body is not rotatable when fitted into the hole. A flange extends at the head of the body. The fastener body can be used to secure mats one to another by fitting within aligned holes of overlapping mats simultaneously. A rigid locking rod is fit within a longitudinal bore within the fastener body, the rod having an enlarged head section, a longitudinal shaft midbody section and a foot section. The rod is in contact with the bore, but can be rotated upon the application of torque to the rod relative to the body to position a flanged end of the locking rod to either be extended out to engage against the mat about the hole or to be recessed. The flanged end of the body and the extended flanged end of the rod lock the mats in together. The fastener is of a sufficient length so that a small amount of movement is provided to the mats when secured by the fastening device so as to decrease tension in the mats. The two sections of the body can be unattached and the rod or either body section may thereby be replaced should such element fail.

### FIELD OF THE INVENTION

The invention relates to a fastening device utilized to secure articles, in particular to fasten mats together.

### BACKGROUND OF THE INVENTION

Rigid large sized industrial mats can form structural supports and may be used to cover a recessed area or an area of soft ground, so as to prevent a person or vehicle crossing over the covered area from falling into the recess or sinking into the soft ground. In order to cover a large area multiple mats may be placed adjacent to each other and be secured together. This placement ensures a large area may be covered by a structurally sound overlay of mats. Such mats are described for example in U.S. Pat. No. 6,511,257, issued to OLS Consulting Services, Inc.

One method of securing multiple mats together is to fasten them with fastening devices received into holes cut into each mat. In this manner multiple mats may be placed so as to overlap with the holes in each overlapping mat being aligned. The fastening device is received into the aligned holes and causes the mats to remain connected one to another.

A fastener device employed in the securing of mats must be durable and able to withstand heavy pressures. Mats may be used to overlay roadways or swamp areas. Therefore, a fastener device must withstand elemental wear and tear as well as the accumulation of mud and dirt. Moreover, a fastener device must have the requisite strength to prevent secured mats from being pulled apart and to withstand torque applied by objects passing over the secured mats.

Standard fastening devices have been formed of a single piece plastic housing moulded around a locking rod. Such a fastening device is disclosed in U.S. Pat. No. 6,511,257. This method of manufacture makes it necessary to replace the entire fastening device, should one of its components fail. Furthermore, standard fastening devices incorporate a locking rod that is die cast and weak, thereby, being susceptible to breakage due to either pressure applied thereto especially when employed in below-freezing winter conditions. After either the plastic housing or the locking rod breaks the mats can separate resulting in an unsafe situation for persons using the mats.

Furthermore, previous mat fastening devices have been built to a length that does not allow for movement between mat flanges. The result is that excess stress is placed on the fastening device during installation. The fastening device is thereby weakened and becomes more prone to cracking or breaking during use.

The present invention is formed to overcome at least some of the disadvantages of the prior art.

### SUMMARY OF THE INVENTION

The present invention provides: a fastener including a rigid fastener body shaped so as to be insertable into a hole in a mat and having a flange at the head, the body being formed so that the fastener body is not rotatable when fitted into the hole whereby the fastener body may secure mats one to another by fitting within aligned holes of overlapping mats simultaneously; said fastener body being formed of at least a first body section and a second body section divided along a longitudinal axis whereby the first body section and the second body section may be fitted together and fixably attached by an attachment means to form the fastener body. A longitudinal bore within the fastener body formed between the first body section and the second body section. A rigid locking rod is formed to include an enlarged head section, a longitudinal shaft midbody section and a foot section the locking rod being sized so the head and midbody sections are received within the longitudinal bore so that they are in contact with the bore whereby the locking rod resists rotation within the longitudinal bore, but can be rotated upon the application of torque to the rod relative to the body. The enlarged head of the locking rod can be formed to accept a torque tool such as by forming a slot or a hex opening therein. The locking rod is turned to thereby position the flanged end of the locking rod to either be extended out to engage against the mat about the hole or to be recessed. To facilitate locking of the mats the flange of the foot end can be shaped so as to alternatively extend beyond the exterior edge of the fastener body and be aligned with the fastener body when the locking rod is rotated within the longitudinal bore.

The two-piece construction of the fastener body provides that the fastening device may be repaired should the fastener body crack or break. Moreover, in the instance that the locking rod breaks, the fastener body may be separated into two body sections so that the locking rod may be extracted and replaced. Thus, the fastening device is repairable and does not necessarily need to be discarded in its entirety if one element of it fails. It is to be understood, that the body can be formed with more than two sections, as desired, provided that it continues to be operable to permit access to the rod. The body can be formed to be non-rotatable in the hole by forming the body to correspond to the hole shape or by other means, such as by use of teeth etc., which engage against the hole.

The locking rod can be sand cast using ASTM A148 Grade 150-135 steel. The shape and profile of the locking rod is smoothly tapered, being devoid of sharp edged shoulders and abrupt angular changes of greater than 60°. These structural aspects enhance the strength and durability of the locking rod. The lack of sharp corners reduce the concentration of stress. A locking rod formed in this manner can avoid metal fatigue failure and withstand sub-freezing weather conditions.

The preferred embodiment of the fastener device of the invention is of a sufficient length that the overlapping mats have a selected degree of freedom of movement after being locked together by the fastening device. In particular, the length of the fastener between the body flange and the foot flange is selected to be greater than the thickness of the overlapping mats between their fastener bearing surfaces. This length ensures that field installation may be performed in a manner that is both faster and easier than the installation of standard fastening devices. The length of the fastening device of the invention further acts to reduce the stress placed on the fastening device by allowing for a small amount of movement between the mats.

In use, the assembled fastening device is inserted into aligned holes of overlapping mats. At the point of insertion the locking rod is turned so that the flange of the foot end is aligned with the fastener body, such that the flange does not resist insertion into the hole. Once the fastening device is received by the aligned holes in the overlapping mats the locking rod may be rotated in the longitudinal bore to cause the locking rod to turn sufficiently so that the flanges on the foot end extend beyond the outside of the fastener body and beyond the edges of the hole to engage under the mat. Directional indicators may be included on the head of the locking rod to aid in the assessment of whether the locking rod has been rotated a sufficient amount to have the flanges engage under the mat. In this position the portion of the flanges of the foot end extending beyond the outside of the fastener body and the flange at the head of the fastener body will prevent the fastener from being removed from the mat holes. The contact between the locking rod and the longitudinal bore is sufficiently tight that the tension between the surfaces prevents the occurrence of free turning relative to each other.

These and other features and advantages of the fastening device according to the present invention will become more apparent with reference to the following detailed description and drawings.

### BRIEF DESCRIPTION OF THE DRAWINGS

FIG. 1 is a front view of a fastening device of the invention with a locking rod received into a connected fastener body and rotated so that its foot end is aligned with the fastener body;

FIG. 2 is a cross-section of the insertion of a fastening device within aligned mat holes.

FIG. 3 is a top view of the fastening device of the invention with the locking rod received into the connected fastener body;

FIG. 4 is a side view of a fastening device with the foot end aligned with the fastener body;

FIG. 5 is a side view of a fastening device with the flange of the foot end extending beyond the outside of the fastener body;

FIG. 6 is a back view of a body section with the locking rod inserted into the portion of the longitudinal bore extruded therein;

FIG. 7 is a perspective view of a body section;

FIG. 8 is a side view of a body section;

FIG. 9 is a front view of a body section;

FIG. 10 is a perspective view of a fastener body;

FIG. 11 is a bottom view of a fastener body;

FIG. 12 is a front view of a fastener body;

FIG. 13 is a side view of a fastener body;

FIG. 14 is a perspective view of the locking rod;

FIG. 15 is a front view, partly in section, of the locking rod;

FIG. 16 is a side view of the locking rod;

### DETAILED DESCRIPTION OF THE INVENTION

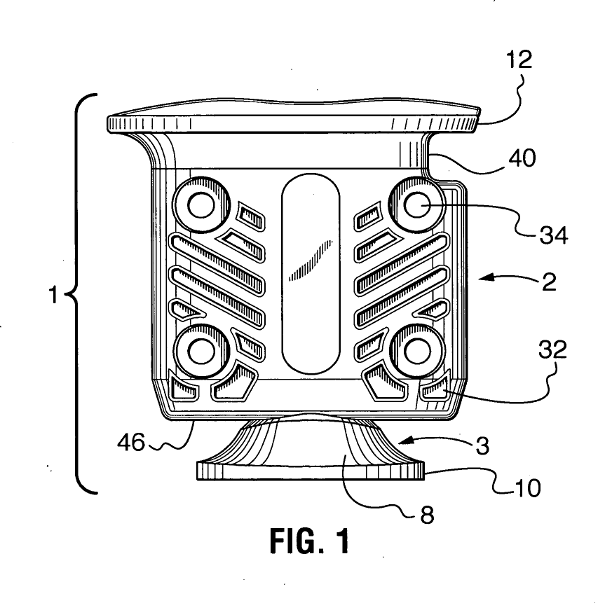

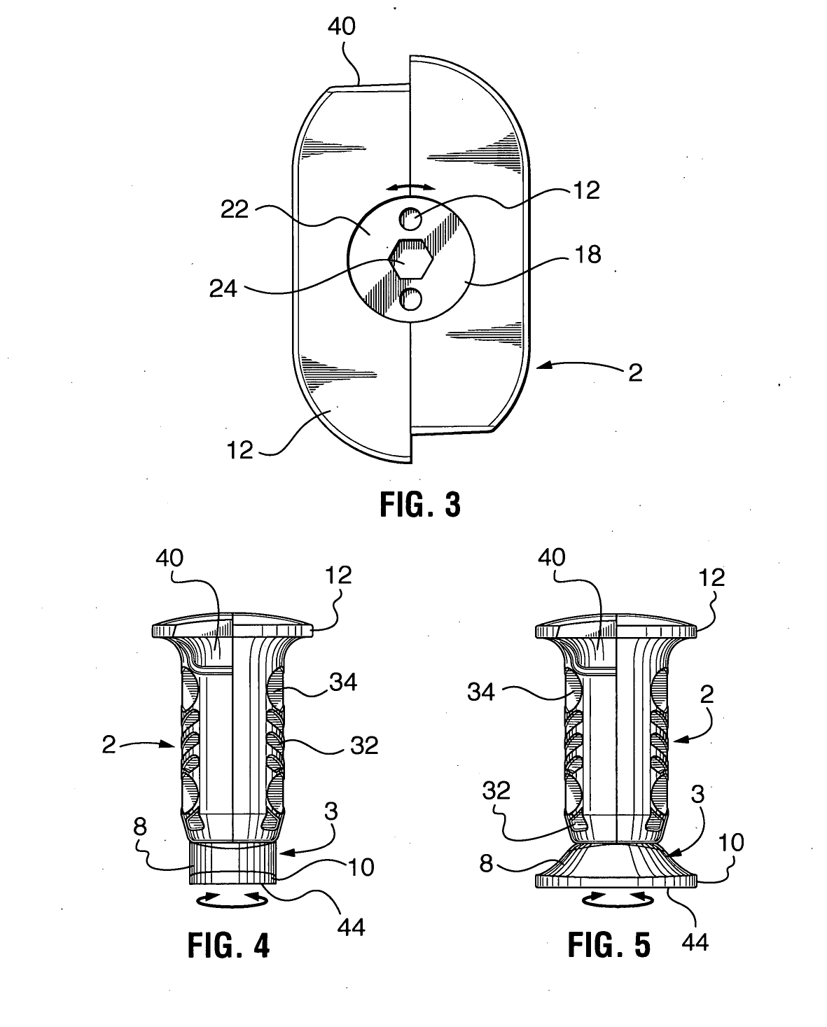

Referring now to FIG. 1 the fastening device 1 of the invention is shown. The fastening device 1 comprises a fastener body 2 and a locking rod 3 extending therethrough. The locking rod includes a foot end 8 exposed on an end of the fastener 10 extending outwardly therefrom. The locking rod is rotatable along its long axis to turn the flange 10, as desired. Upon rotation of the locking rod the flange 10 of foot end 8 is moved from a position of alignment with the fastener body, as shown in FIG. 4 to varying positions whereby the foot flange 10 extends beyond the side surface of the fastener body as shown in FIG. 5. The locking rod 3, and thus the attached foot end 8, may be rotated in both clockwise and counter-clockwise directions as indicated by arrows in FIGS. 3-5. Fastener body 2 also includes a flange 12. The fastener body flange 12 is formed at an end of the fastener opposite foot end 8.

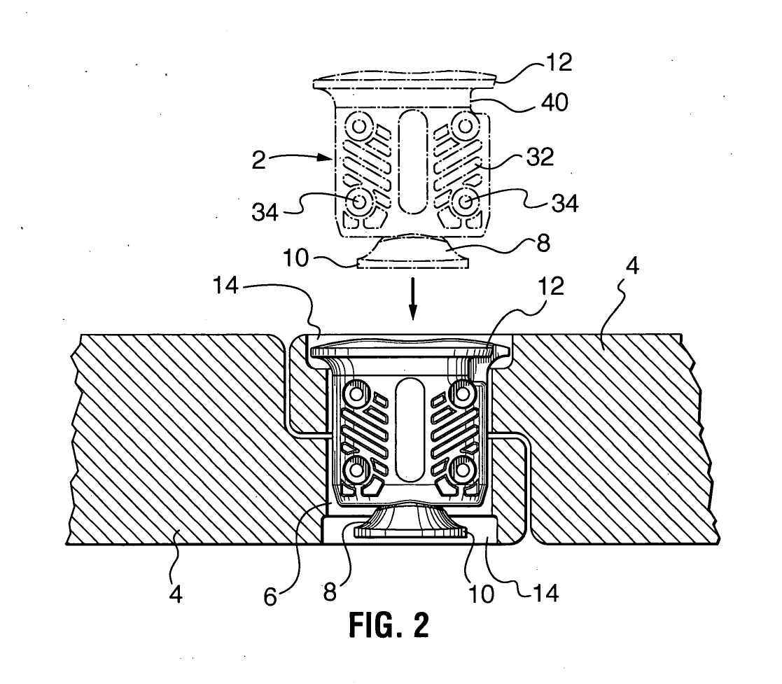

Referring now to FIG. 2 the fastener device of the present invention can be used to hold mats together. Rigid mats 4 are overlapped one with another in a manner whereby the holes 6 in each mat are aligned. The fastening device 1 is aligned with the holes 6 in the mats, said fastening device being shaped so as to be insertable into the aligned holes with its shape selected with consideration to the holes so as to resist rotation therein. Prior to the insertion of the fastening device 1 into the aligned holes 6, the locking rod 3 fit within the fastener body 2, as shown in FIG. 3, must be rotated to cause the foot end 8 to be aligned with the fastener body 2, as shown in FIG. 4. When the foot end 8 is in an aligned position the fastener device may be inserted into the aligned holes 6 in the overlapping mats 4 until flange 12 abuts against the edges of the hole, preventing further insertion. Once so inserted, the locking rod 3 can be rotated to cause the flange 10 of the foot end 8 to extend beyond the side surface of the fastener body 2, as shown in FIG. 5. In this extended position the flange 10 will prevent the fastener device 1 from being extracted from the aligned holes by extending beyond the walls of the holes so as to make contact with the edge of the mat because. In a like manner the flange 12 of the body 2 which has a larger circumference than the circumference of the aligned holes, prevents the fastening device 1 from being removed from the holes 6 when the foot end 8 of the fastening device is pulled on. The result is that the overlapping mats are enclosed between the body flange 12 and the flange 10 of the extended foot end 8. In this manner the fastening device secures the overlapping mats to each other. In one embodiment the fastening device is received within holes that incorporate a depression 14 at both ends of the hole 6, as shown in FIG. 2. In this embodiment the body flange 12 and the foot flange 10 extend outside the hole but remain within the depressions 14 of the mats.

The preferred embodiment of the invention is created so that the distance between the flange 12 of the fastener body 2 and the flange 10 of the foot end 8 is slightly wider than the depth of the overlapped mats that the fastening device is used to secure. A fastening device of the resulting length ensures that a small amount of freedom of movement is provided to the mats when secured by the fastening device so as to decrease tension in the mats.

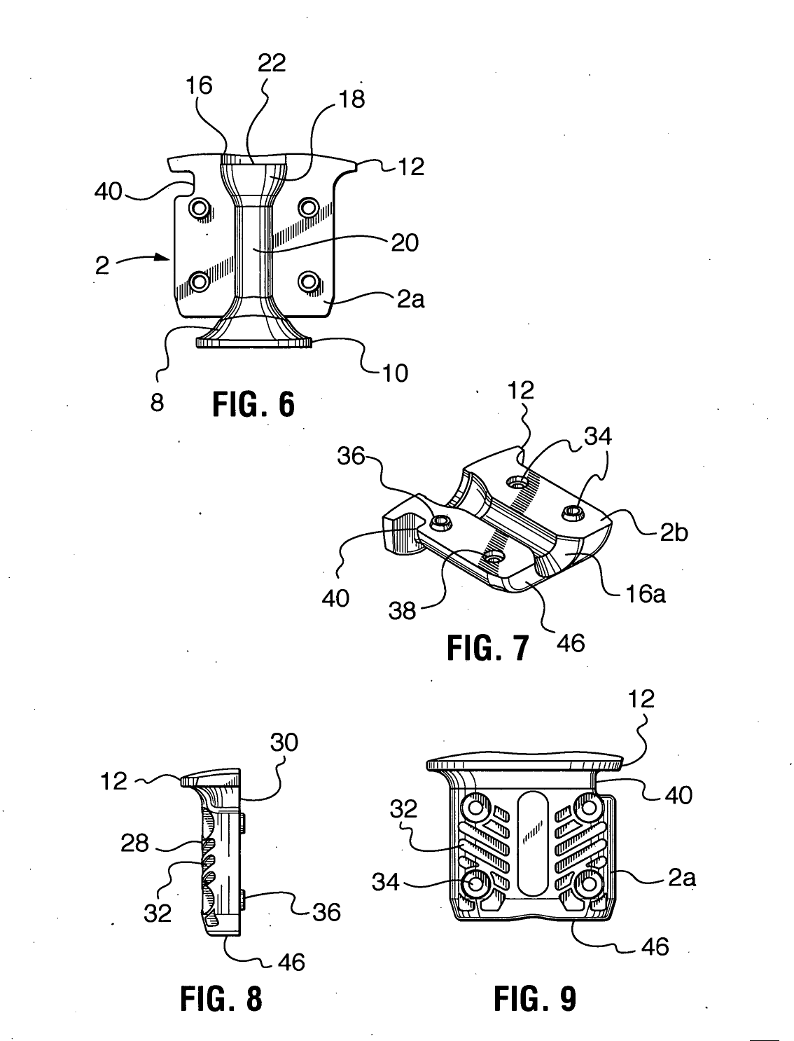

Referring now to FIG. 3, the locking rod 3 is mounted in a longitudinal bore 16 through the fastener body 2. In the preferred embodiment a head 18 and a midbody 20 (FIG. 13) of the rod 3 are disposed within the longitudinal bore 16 with the foot end 8 extended below the fastener body 2, and a head top surface 22 exposed, as shown in FIG. 6.

In the preferred embodiment a hex 24 is formed in the flat end 22 of the head section 18, as shown in FIG. 3, for the purpose of receiving a torque-tool, such as an Allen key or a screwdriver. The application of the torque tool will cause the locking rod 3 to be rotated in the longitudinal bore 16 in either a clockwise or counterclockwise direction as indicated by the arrows of FIG. 3. Torque is required to rotate the locking rod 3 due to the snug contact between the walls of the longitudinal bore 16 and the walls of the locking rod 3. The tensioned relationship between the locking rod and the longitudinal bore ensures that there is no freedom of movement between the two elements without the application of torque to the rod relative to the body. In the preferred embodiment the enlarged head 18 has at least one directional indicator 26 in the flat top surface 22. The directional indicator 26 shows the rotation of the locking rod as its position is altered according to the rotation of the locking rod 3. Preferably, directional indicators 26 are positioned in alignment with the flange 10 on the footed end 8.

As shown in FIGS. 6-9 a preferred embodiment of the fastening device includes a fastener body 2 formed from a first body section 2a and a second body section 2b, separated along a longitudinal axis. In a preferred embodiment for ease of holding and manufacture the two body sections are identical. Each body section 2a has a longitudinal elongated shape formed so as to fit within the mat holes 6 in a non-rotatable manner. Preferably each body section 2a is u-shaped, having a rounded outer facing surface 28 and a virtually flat inner facing surface 30 with an elongate hollow 16a selected to fit about the rod 3, so that when the two body sections 2a and 2b are attached the fastening body forms an oblong shape to be non-rotatably fit within an oblong shaped mat hole 6. It is noted that alternate body 2 shapes will be required for varying hole 6 shapes. Means other than the shape of the body 2 can be used to cause the body 2 to be non-rotatable in the hole, such as teeth that engage against the hole. Flange 12 extends from the upper edge of the fastener body creating a shoulder in all directions about the fastener body 2. The preferred embodiment of the body section can have indentations 32 formed in its outer surface as will be appreciated, which facilitate polymeric moulding.

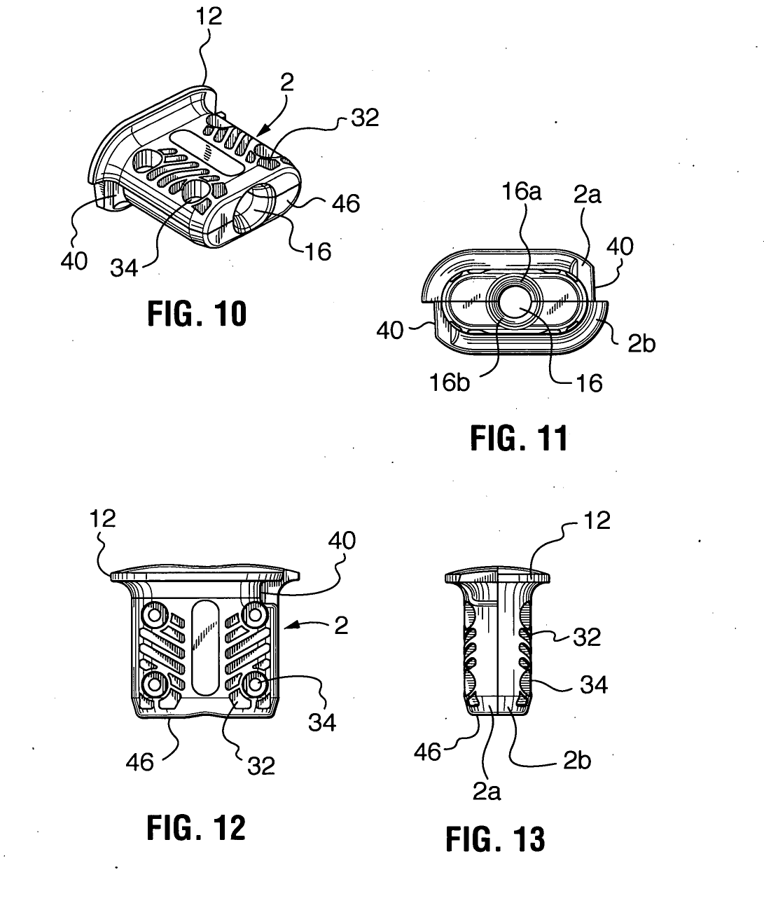

The longitudinal bore through which the rod extends is formed by the longitudinal hollow 16a cored out of the inner face of the body section as shown in FIG. 7. The hollow 16a should be shaped to match the contours of the locking rod 3 so that the locking rod may be placed within the hollow, as shown in FIG. 6. Upon the attachment of two body sections 2a and 2b the hollow 16a and 16b in each body section collectively form a longitudinal bore 16 through the fastener body 2 as shown in FIGS. 10 and 11.

In one embodiment of the invention at least one aperture 34 is cut on either side of the hollow 16a and 16b to receive an attachment means such as pins, bolts, rivets, etc., as shown in FIG. 6. Referring to FIGS. 10-13 when a first and second body section 2a and 2b are fit with inner faces 30 together adjacent and apertures 34 aligned an attachment means may be used to fixably secure the two body sections. Preferably a bolt is affixed into a pair of aligned apertures 34 to secure the first and second body sections together to create the fastener body 2 the bolt being anchored by a nut. It is to be noted that other means can be used to secure the body sections together such as adhesives, snap together arrangements or metal bands. In such embodiments, apertures need not be used, but other modifications may be required. It is noted that while there are various attachment means, some means may not be completely useful when considering reusability of the body sections.

In one embodiment of the invention the apertures 34 may include raised 36 or recessed 38 perimeter portions on the inner facing side 30 of the body section 2a as shown in FIG. 7. Preferably the ridges 36 and recesses 38 are built in a manner so that alternate apertures 34 include ridges 36 and recesses 38 as shown in FIG. 7. Of course other ridges/recesses can be formed on other positions on the facing surfaces. Ridges 36 on a first body section 2a are formed to fit within recesses 38 on a second body section 2b to ensure and maintain correct positioning. It is noted that both body sections may be formed from a single mould which has alternating ridges and recesses so that when two sections are aligned with inner surfaces facing a ridge on a first body section aligns with a recess on a second body section. In an alternate embodiment of the invention, whereby the body sections are not formed from a single mould, the alignment of ridges 36 and recesses 38 may be achieved by designing a first body section 2a to include only ridged apertures 36 to be fit with a second body section 2b including only recessed apertures 38.

The body sections 2a and 2b may be formed of any type of plastic or other mouldable rigid material that is capable of performing in the mat environment, including, for example, standard quality high density polyethylene (“HDPE”) or ultra high molecular weight plastic. Preferably the body sections are formed from injection moulded thermoplastic, such as a high grade HDPE.

As shown in FIG. 9 a portion of the body section can be removed to form a depression 40 on the fastener. The depression 40 aids in the removal of the fastener from a hole by inserting therein a prying device such as a bar and levering the bar against the mat surface. Alternatively an extraction tool may be used grip the fastener at the depression to extract the fastener out of the hole by force.

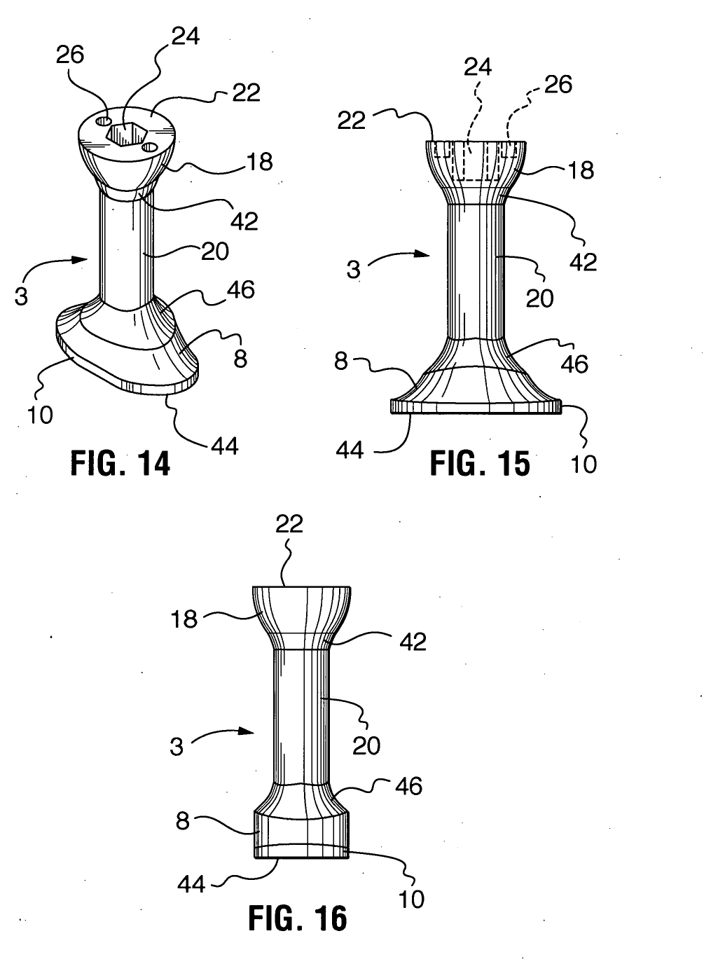

Referring now to FIGS. 14-16, the locking rod 3 is a rigid member formed to include three integral elements, head section 18, midbody 20 and foot end 8. The midbody 20 is a cylindrical shaft that extends between the head section 18 and the foot end 8.

The head section 18 has a diameter greater than the midbody 20 such that it is enlarged. Head section 18 thereby holds locking rod 3 so that it is prevented from moving down into the longitudinal bore 16, as shown in FIG. 6. In one embodiment of the invention the enlarged head 18 is smaller than the width of the flange 12 of the fastening body 2 since the head is, in this embodiment, surrounded by the body, it has a circular shaped perimeter to permit rotation therein.

The lower walls 42 of the cylindrical head taper gradually towards the shaft of the midbody 20. The integration of the head 18 and the midbody 20 is substantially devoid of right angles, sharp shoulders and abrupt angular changes of greater than 60°.

The midbody 20 is integrated with foot end 8 at the opposite end from where it is integrated with the head 18. The foot end 8 can be structured in a variety of configurations, one embodiment being a flat bottom 44 sized to be either the same size and shape as the bottom 46 of the fastener body or a size and shape that is smaller than the widest portion of the bottom of the fastener body but is wider than the narrowest portion of the bottom of the fastener body in at least one position. Preferably the flange 10 of the foot end 8 is an oblong shape, as shown in FIG. 14. It is noted that the shape of the flange 10 may vary according to the shape of the body 2. The shape of the foot flange 10 ensures that it may be aligned with and positioned entirely beneath the fastener body 2 in one position shown in FIG. 4 and extend beyond the outer edge of the fastener body in another position shown in FIG. 5, the position of the foot flange is selected by rotation of the locking rod 3.

The upper walls 46 of the foot end 8 slope away from the flange 10 upwards towards the narrower midbody shaft. The locking rod 3 may be created from any rigid material including a variety of steel materials. Mild steel may be utilized, such as grade 5 steel. The preferred embodiment of the locking rod 3 is sand cast using ASTM A148 Grade 150-135 steel or grade 8 steel.

In the preferred embodiment, the body 2 is a bright colour and is thereby easily visible. While in use a fastening device can be lodged in mud or snow and the bright colour of the body 2 allows the fastening device 1 to be located quickly.

Naturally, the invention is not limited to the embodiments described and variants can be made thereto without going beyond the ambit of the invention as defined by the claims.

We claim:

1. A fastening device for securing a mat comprising:
a rigid fastener body having a flange said fastener body being shaped so as to be fitable into holes formed through a mat and not rotatable when fitted within the holes whereby the fastener body secures mats one to another by fitting within the holes formed in the mats simultaneously;
said fastener body being formed of at least a first body section and a second body section whereby the first body section and the second body section are fitted together and attached by an attachment means to form the fastener body;
a longitudinal bore formed between the first body section and the second body section, the longitudinal bore being open at its top and bottom ends;
a rigid locking rod formed to include an enlarged head section, a longitudinal shaft midbody section and a foot section the locking rod being sized so the midbody section fits within the longitudinal bore in contact with the bore whereby the locking rod is rotatable within the longitudinal bore;
said foot end section having a flange shaped to alternatively extend beyond the exterior edge of the fastener body and be aligned with the fastener body according to the rotation of the locking rod within the longitudinal bore.

2. The fastener device of claim 1 wherein the enlarged head of the locking rod includes a directional indicator whereby the position of the directional indicator will be altered when the locking rod is rotated.

3. The fastener device of claim 1 wherein the first body section and the second body section are formed of injection moulded thermoplastic being high grade high density polyethylene.

4. The fastener device of claim 1 wherein the fastening means utilized to releasably attach the first body section to the second body section is a bolt secured with a nut.

5. The bolt of claim 4 wherein the said bolt is fit through an aperture in the first body section and an aperture in the second body section that correspond one to another when the first body section and second body section are fit together.

6. The fastener device of claim 1 wherein the locking rod is created from ASTM A148 Grade 150-135 steel formed by steel sand casting.

7. The fastener device of claim 1 wherein the locking rod is formed to be devoid of right angles and sharp edges.

8. The fastener device of claim 1 wherein the distance between the flange and the foot end is greater than the depth of the overlapping mats, whereby the overlapping mats have some freedom of movement.

9. The fastener device of claim 1 wherein the head of the locking rod is smaller than the diameter of the flange.

10. The fastener device of claim 1 wherein the head is formed to include a hex of a depth and shape to accept a tool, whereby the tool may be used to turn the locking rod and thereby position the foot end section of the locking rod.

11. A fastening device for securing a mat comprising:
a rigid fastener body having a flange said fastener body being shaped so as to be fitable into holes formed through a mat and not rotatable when fitted within the holes whereby the fastener body secures mats one to another by fitting within the holes formed in the mats simultaneously;
a longitudinal bore formed within the fastener body being open at its top and bottom ends;
a rigid locking rod formed to include an enlarged head section, a longitudinal shaft midbody section and a foot section the locking rod being sized so the head and midbody sections fit within the longitudinal bore so that they are in contact with the bore whereby the locking rod is rotatable within the longitudinal bore;
said rod being formed so that the head and the foot smoothly taper to connect with the midbody;
said foot end section having a flange shaped to alternatively extend beyond the exterior edge of the fastener body and be aligned with the fastener body according to the rotation of the locking rod within the longitudinal bore.

12. The fastener device of claim 11 wherein the enlarged head of the locking rod includes a directional indicator whereby the position of the directional indicator will be altered when the locking rod is rotated.

13. The fastener device of claim 11 wherein the first body section and the second body section are formed of injection moulded thermoplastic being high grade high density polyethylene.

14. The fastener device of claim 11 wherein the fastener body is formed of at least a first body section and a second body section divided along a longitudinal axis whereby the first body section and the second body section are fitted together and attached by an attachment means to form the fastener body;

15. The fastener device of claim 14 wherein the fastening means utilized to releasably attach the first body section to the second body section is a bolt secured with a nut.

16. The bolt of claim 15 wherein the said bolt is fit through an aperture in the first body section and an aperture in the second body section that correspond one to another when the first body section and second body section are fit together.

17. The fastener device of claim 11 wherein the locking rod is created from ASTM A148 Grade 150-135 steel formed by steel sand casting.

18. The fastener device of claim 11 wherein the distance between the flange and the foot end is greater than the depth of the overlapping mats, whereby the overlapping mats have some freedom of movement.

19. The fastener device of claim 11 wherein the head of the locking rod is smaller than the diameter of the flange of the fastener body.

20. The fastener device of claim 11 wherein the head is formed to include a hex of a depth and shape to accept a tool, whereby the tool may be used to turn the locking rod and thereby position the foot end section of the locking rod.
